(19) United States
(12) Patent Application Publication
(10) Pub. No.: US 2014/0214548 A1
(43) Pub. Date: Jul. 31, 2014

(54) User Profiling Using Submitted Review Content

(71) Applicant: ECOLE POLYTECHNIQUE FEDERALE DE LAUSANNE (EPFL), Lausanne (CH)

(72) Inventors: Boi Faltings, Preverenges (CH); Claudiu-Cristian Musat, Lausanne (CH); Yizhong Liang, Preverenges (CH)

(73) Assignee: Ecole Polytechnique Federale de Lausanne (EPFL), Lausanne (CH)

(21) Appl. No.: 13/754,136

(22) Filed: Jan. 30, 2013

(51) Int. Cl. G06Q 30/02; G06F 17/30

(52) U.S. Cl. CPC G06Q 30/0269; G06F 17/30702
USPC 705/14.66; 707/803; 707/755; 707/748

(57) ABSTRACT

A computer-implemented method for generating a user profile of a user of an online platform, a computer-implemented method for providing a first user with targeted information and a computer-implemented method for providing a user of an online platform with targeted advertisements.

### FIELD OF THE INVENTION

The present invention relates to the provision of personalized information to users of online platforms. More specifically, the present invention relates to a computer-implemented method for generating a user profile for a user of an online platform, a computer-implemented method for providing a user of an online platform with targeted information and a computer-implemented method for providing a user of an online platform with targeted advertisements.

### BACKGROUND OF THE INVENTION

Nowadays, it has become a usual habit for numerous consumers around the world to purchase products or services via dedicated e-commerce, i.e. online, platforms. The number of such online platforms where products and services can be purchased (amazon, online grocery stores, etc.) has therefore exploded over the last twenty years. In some markets, these online platforms have become the favorite, if not the only, means for consumers to purchase products or services. However, consumers who purchase products from online platforms such as e-commerce websites are not able to see, touch or interact with such product or service before it is actually delivered. Indeed, it is for example not possible anymore to take the dreamed-of photo camera in hands in order to determine if it is not too heavy or bulky, to experience the quality of the materials used in a portable device, to discuss the quality of service provided by a hotel directly with the travel agent who has spent some time in such hotel, etc. Since the product or service is usually stored remotely from the consumer, such habits that consumers had in the past when all goods or services were purchased in normal stores, in contrast to online stores, are not applicable to online commerce.

In order to get around this drawback, it has thus become a habit for consumers to make use of dedicated online platforms which gather feedbacks, i.e. reviews, about products or services. In the field of travel, it is for example possible to make use of the website www.tripadvisor.com which provides reviews about hotels. Such reviews are submitted by consumers, i.e. users, when they want to share their point of view about hotels they have stayed in. Other users can then retrieve this information which has been submitted by other users. Following for example a query with respect to a specific hotel, they are then presented with a number of reviews, written and submitted by other users, which provide them a way, before actually submitting a booking, to determine from the feedback submitted by others whether a specific hotel is able to satisfy their needs, interests, wishes, etc.

However, someone who has already visited the above cited website knows that, despite providing a great source of information, it still suffers several downsides.

First of all, when a user makes a query about a specific hotel, he or she is provided with a number of reviews that do not necessarily address his or her needs and interests. Indeed the needs and interests of a user can be different from those of the people that have previously submitted the reviews. In other words, it is not possible to provide the user with a list of reviews which address only his or her needs and interests. The user thus has to browse through the reviews in order to determine, amongst these reviews, those that are relevant. This operation of sorting out which reviews are relevant with respect to one's specific needs and interests is very time-consuming and can even discourage people from making use of such platforms. A first problem of these platforms is thus that they do not provide means for retrieving only targeted, i.e. personalized, information.

Moreover, since such platforms do not provide means for sorting out the information with respect to people interests, they do not provide means for making this provision of information adaptive. Indeed, the needs and interests of a specific user can evolve over time. However, this evolution is not taken into account by such platforms. In other terms, a user making a query about a specific hotel would be presented results that do not depend on the fact that its personal needs and interests have been evolving over time. The additional amount of information that the user is provided with depends on the amount of new data that has been collected by the platform as a whole, but it does not depend on the evolution of the user's personal needs.

Moreover, it is also known that there are clever people who have understood the great opportunity given by such platforms in terms of marketing purposes. Those users do not hesitate to submit “fake reviews”, speaking highly of the merits of their products or denigrating the products or services provided by their competitors. There is thus also a problem of reliability of information provided on such online platforms.

Furthermore, a problem for the owners of such websites resides in the fact that the process of submitting a review is relatively time-consuming for a user. As such, users do not often decide to invest part of their time for submitting a review. Consequently, as users do not always perceive the benefits for them to submit reviews, only a few decide to actually submit reviews. Owners of such platforms then have to face the problem of not being able to gather a sufficient amount of information. However, the more information they would be able to get, the more they would able to determine for example whether a specific review turns out to be a “fake review”. Indeed, the more information is collected, the easier it is, by comparing the reviews with one another, to determine whether one specific review concerning one hotel strangely go against the vast majority of the reviews that have been submitted. So far, the owners of such platforms have not been able to provide convincing incentives for people to submit more reviews. Solving this problem would however allow owners to increase the amount of data they receive so as to improve the service they provide, in other words their ability to provide balanced and reliable information.

The present invention intends to remedy to these drawbacks.

### SUMMARY OF THE INVENTION

The following definitions will be used throughout the present specification:

The term “review” is defined as information submitted by users criticizing, in a positive or negative way, a certain kind of product or service. In other words, a “review” contains information that provides a feedback about a product or a service. A review can be submitted by a user in the form of data in formats such as text format, multimedia format (audio, video or pictures) or even combinations of those. A review can for example comprise parts in text format and parts in pictures or videos formats. The website www.tripadvisor.com only collects and presents reviews which are submitted by users as data in text format.

The term “item” is defined as a product or service of any kind that can be purchased or rented. It thus includes products such as consuming goods (for example: portable devices, cars, garments, etc.), industrial goods (machines, spare parts, etc.) or any other type of products that can be purchased or rented, either online or through traditional commerce channels. It also includes all kinds of services (travel booking, hotel booking, car renting, human resources related services, etc.) that can be purchased or rented either online of via traditional commerce channels.

The term “topic” is defined as a set of one or more words that define(s) a specific theme or subject. For example, the topic “cleanliness” can be established and, the said topic may contain expressions such as “clean”, “dirty room”, “full of dust room”, “you could eat on the ground of this room”, etc. All these expressions address indeed, in one way or another, the same topic of “cleanliness”.

The term “word” is defined, traditionally, as a combination of letters that symbolizes and communicates a meaning and may consist of a single morpheme or of a combination of morphemes. However, within the spirit of the present invention, the term “word” relates more generally to a sequence of characters or signs (Chinese and Japanese characters included) or, even more generally, to one or several n-grams.

The expression “sentiment-related information” is defined as pieces of information that provide information about a sentiment. For example the following expression “I entered the room” does not provide sentiment-related information whereas the expression “the room was clean” provides sentiment-related information. The second expression indeed provides a specific opinion, i.e. sentiment, about the room. Within the spirit of the present invention, sentiment-related information can be derived from text by performing semantic and syntactic analysis but it can also be derived, in the case of information submitted in a format which is not text, such as for example video data, from facial recognition means, voice recognition means, etc.

The expression “explicitly collected data” is defined as information that is directly collected from users via specific means that allow users to be asked directly about their personal needs or interests. Examples of “explicitly collected data” are data which are collected from users via surveys, questionnaires, polls, etc.

The expression “implicitly collected information”, in contrast to the above, is defined to be information derived directly from the web environment without any direct interaction with users. “Implicitly collected data” correspond to pieces of information which are derived from, for example, web browser history, purchasing habits, social networks memberships, etc.

The term “parser” is defined as a module which retrieves useful pieces of information from a specific content. In the case of data submitted in text format, a parser is able to distinguish specific words, expressions or sentences. A parser, as defined within the spirit of the present invention, is also able to identify in a content provided in video or picture format useful pieces of information.

The present invention relies on several aspects which allow the above-mentioned problems to be solved.

Firstly, in order to be able to provide targeted information to a user, it is mandatory to establish beforehand a way of determining the needs and interest of this specific user. A first aspect of the present invention thus concerns a method for generating a user profile of a user of an online platform which is based on the reviews submitted by said user.

A computer-implemented method for generating a user profile of a user of an online platform in accordance with the present invention comprises the steps of:
acquiring a review submitted by said user, wherein said review concerns an item purchasable on said online platform and contains data in formats selected from a group consisting of text format, multimedia format and combinations thereof;
performing an analysis of said review so as to generate a collection of topics associated with said user, wherein said collection of topics contains at least one topic; and
creating said user profile by storing a reference to said collection of topics in relation with information identifying said user.

It thus becomes possible to generate a user profile for a user by making use of only data contained in reviews submitted by a user. As soon as a user submits a review, its personal needs and interests are derived from the data contained in the submitted review. This way of generating a user profile describing a user's specific needs and interests relies on the concept that it is assumable that, when people submits reviews, the content of these reviews probably contains views on aspects important to those users.

According to one characteristic of the invention, the method for generating a user profile of a user of an online platform can further comprise a step of incorporating explicitly collected data in said user profile.

This characteristic allows traditional ways of collecting information to be used. As such, it further improves the pertinence of the generated user profile. User profiles created by performing the steps in accordance with the method of the present invention thus reflect in a better way, i.e. a more complete way, the needs and interests of users.

According to a further characteristic, the method for generating a user profile of a user of an online platform can further comprise a step of incorporating implicitly collected data in said user profile.

This characteristic enables the use of the huge amount of information available on the web in order to make user profiles even more complete, precise and reliable. As stated above, implicitly collected data is data collected by deriving information from users' purchasing habits, users' social networks memberships, online browsing histories, etc. The incorporation in the user profiles of such data allows the user profiles to profit from this information so as to become avatars whose personal needs and interests get as close as possible to those of the user to which they are related.

According to another characteristic, said step of performing an analysis of said review can include a step of deriving, from said review, at least one data part in text format and a step of parsing said data part so as to retrieve from said data part at least one relevant set of words, wherein said set of words comprises at least one word.

In this respect, it becomes possible to extrapolate from a review, which can comprise information in text or multimedia format, at least one part, which is in text format or which can be transformed in a text format (for instance a video transcript if said review is submitted in video format), so as to perform further analysis.

According to another further characteristic of the method for generating a user profile of a user of an online platform in accordance with the present invention, said step of performing an analysis of said review can include a step of comparing said set of words with a predefined collection of topics.

It thus becomes possible to establish which information contained in a review might be useful, i.e. to establish which parts of a review address generic topics that have been defined.

According to another further characteristic of the method for generating a user profile of a user of an online platform in accordance with the present invention, said predefined collection of topics can be established by a set of human judges.

It is thus possible to make use of human intelligence to define topics that might be addressed in the reviews. This way of doing increases the reliability of the analysis that is performed on a review.

According to another further characteristic of the method for generating a user profile of a user of an online platform in accordance with the present invention, said predefined collection of topics can be built by making use of artificial intelligence means.

This characteristic addresses the use of artificial intelligence means for determining automatically, for each product or service that can be purchased on said online platform, a set of generic topics that might be pertinent with respect to said products or services. Such characteristic thus allows to either replace or complement the input of (combinations of Al and human I are possible) human judges for the definition of the predefined collection of topics, thereby allowing the method in accordance with the present invention to be, in this respect, fully or partly independent of human resources.

According to another further characteristic of the method for generating a user profile of a user of an online platform in accordance with the present invention, said step of performing an analysis of said review can include a step of determining sentiment-related information contained in said review.

This characteristic allows the method to be further improved by allowing, when analyzing said review, to focus on data that provide information about a sentiment. These data are indeed likely to provide the most useful information for deriving a pertinent user profile, i.e. a reliable collections of topics, for said user.

According to another further characteristic of the method for generating a user profile of a user of an online platform in accordance with the present invention, said step of determining sentiment-related information can include a step of making use of an automated sentiment determination module so as to determine if at least one word contained in said at least one data part provides sentiment-related information.

This characteristic addresses the use of automated means for determining words contained in a review that provide sentiment-related information. Once again, the method in accordance with the present invention becomes thus totally independent from the use of human resources.

According to another further characteristic of the method for generating a user profile of a user of an online platform in accordance with the present invention, said step of performing an analysis of said review can include a step of determining sentiment-related information contained in said review and said step of determining sentiment-related information can include a step of making use of an automated sentiment determination module which automatically determines at least one part of said review which provides sentiment-related information.

This feature addresses the case of a submitted review that contains data in text format or in multimedia format.

According to another further characteristic of the method for generating a user profile of a user of an online platform in accordance with the present invention, said step of creating a user profile for said user can include a step of assigning a weight to each topic contained in said collection of topics.

As such, the method in accordance with the present invention is able to give, in the user profile, the same, more or less importance to certain topics with respect to others. It thereby provides means for reflecting in a better way the personal needs and interests of a user.

A second aspect of the present invention concerns the use of a user profile for providing a user with useful information.

In this respect, a computer-implemented method for providing a first user with targeted information when said first user enters a process of looking for an item purchasable on an online platform by providing, by means of dedicated searching means provided on said online platform, at least one search-related parameter, comprises the steps of:
determining, by making use of said at least one search-related parameter provided by said first user, a type of item said first user is looking for;
retrieving, from said online platform, a first user profile associated with said first user, wherein said first user profile is linked to a first collection of topics comprising at least one topic;
retrieving, from said online platform, at least one review which concerns an item of said type and which has not been submitted by said first user;
comparing said review with said first collection of topics so as to determine whether said review includes content that relates to at least one topic contained in said first collection of topics; and
assigning a sentiment value to said review.

This method in accordance with the present invention thus provides the ability to make use of a user profile, predefined in accordance with the method for generating a user profile of a user of an online platform as described above, or not, for determining useful information to be presented to a user that enters a process of looking for an item, i.e. a product or a service, to purchase via an online platform.

According to one characteristic of the method for providing a first user with targeted information in accordance with the present invention, said step of comparing said review with said first collection of topics can include a step of determining whether said content provides sentiment-related information.

Here again, the content of said review which provides information about sentiments is the major concern. This characteristic allows the analysis of the review to be focused on this type of content.

According to another characteristic, the method for providing a first user with targeted information in accordance with the present invention can further comprise a step of determining whether the time elapsed from the moment the said review was submitted does not exceed a predefined threshold.

Here the method eliminates old and obsolete reviews, which no longer reflect the realities of the underlying item, and permits the exclusive usage of the content from new reviews.

According another characteristic, the method for providing a first user with targeted information in accordance with the invention can further comprise the steps of:
determining, from said online platform, which second user submitted said review, so as to derive a second collection of topics associated with said second user; and
comparing said first collection of topics with said second collection of topics so as to determine a distance factor for said second user, wherein said distance factor is dependent from the pertinence of said second collection of topics with respect to said first collection of topics.

This characteristic provides means for establishing to what extent topics addressed in a review submitted by a second user are related, i.e. pertinent, to the topics contained in the first user profile. This characteristic further makes it possible to determine whether a review submitted by a second user contains information that might be useful to the first user.

According to another characteristic, the method for providing a first user with targeted information in accordance with the present invention can further comprise a step of determining a relation factor for said second user, wherein said relation factor is dependent from the existence of at least one relationship between said first user and said second user.

This characteristic allows the existence of a relationship between the first user and a second user to be taken into account. Such relationship can for instance be established when social network friendships exist. It can thus be determined whether a review submitted by a second user is more or less likely to provide useful information for a first user. It thus becomes possible to profit from additional information, such as the existence of relationships between users, to further optimize the pertinence of information that is provided to the users.

According to another characteristic, the method for providing a first user with targeted information in accordance with the invention can further comprise a step of providing said first user with a ranked list of purchasable items of said type.

This characteristic relates to a first type of targeted information that can be provided to a user. It specifies the ability to provide a ranked list of products in accordance with a user's personal needs and interests. Products or services are ranked in accordance with such needs and interests and presented accordingly to a user.

According another characteristic, the method for providing a first user with targeted information in accordance with the invention can further comprise a step of providing said first user with a ranked list of reviews that concern items of said type.

This characteristic relates to a second type of targeted information that can be provided to a user. It specifies the ability to recommend a ranked list of reviews to a user, wherein said ranked list of reviews is established in accordance with the user's personal needs and interests.

A third aspect of the present invention relates to the use of the methods as described above for providing users with targeted advertisements.

In this respect, a computer-implemented method for providing a user of an online platform with targeted advertisements comprises the steps of:
retrieving, from said online platform, a user profile associated with said user, wherein said user profile is linked to a collection of topics comprising at least one topic;
comparing said collection of topics with advertising parameters associated with an advertisement contained in a collection of advertisements so as to determine a pertinence factor of said advertisement with respect to said user; and
presenting said advertisement to said user in accordance with said pertinence factor.

### BRIEF DESCRIPTION OF THE DRAWINGS

Other advantages and features of the invention will become more clearly apparent from the following description of specific embodiments of the invention given as non-restrictive examples only and represented in the accompanying drawings in which:

FIG. 1 shows a generic flowchart illustrating the method for generating a user profile of a user of an online platform in accordance with the invention;

FIG. 2 shows a detailed flowchart illustrating the method for generating a user profile of a user of an online platform in accordance with the invention;

FIG. 3 shows a generic flowchart illustrating a first embodiment of the method for providing a first user with targeted information in accordance with the invention;

FIG. 4 shows a generic flowchart illustrating a second embodiment of the method for providing a first user with targeted information in accordance with the invention;

FIG. 5 shows a generic flowchart illustrating the final steps of the first and second embodiment of the method for providing a first user with targeted information in accordance with the invention.

### DETAILED DESCRIPTION

As preliminary remarks, it is here established that the expression “computer-implemented method” should be interpreted as a method that can be implemented by making use of any kind of electronic data processing means. Preferably, the methods in accordance with the present invention which are described below are implemented on a server provided within a web environment. Thus, users can interact with and make use of the methods in accordance with the present invention by making use of any type of device that provides internet connection means, i.e. means that allow a link with a server on which the steps of the methods are implemented to be established.

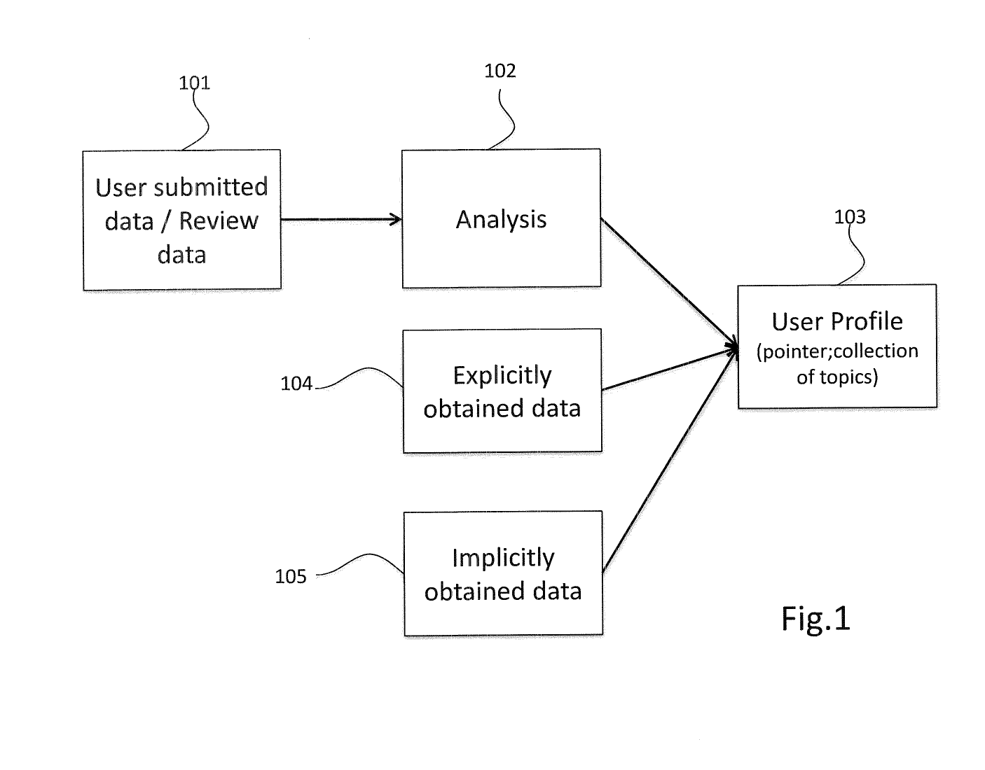

FIG. 1 shows a generic flowchart illustrating a first aspect of the present invention which concerns a computer-implemented method for generating a user profile of a user of an online platform.

As it has been previously said, the preferred way for generating a user profile makes use of the reviews submitted by the users themselves. This way of generating the user profile is induced by the inventive way of thinking that the best way for determining a pertinent and reliable user profile is to rely on the inputs, i.e. the reviews, which are provided by the users themselves while within their normal workflow.

In a first step 101, a review submitted by a user is thus acquired. As it has been previously stated, this review can be submitted in text format, multimedia format or combinations of both. To this end are thus provided, on an online platform where items can be purchased, dedicated means allowing a user to submit reviews, search for items, purchase items and any other type of means that those skilled in the art will agree to be traditional for online e-commerce platforms.

In step 102, an analysis, which will be explained in details below, is performed on the review. This analysis allows a collection of topics associated with said user to be determined in accordance with information provided in said review. This collection of topics may, if desired, be stored in a database provided within said online platform.

In step 103, a pointer, i.e. a reference or a link, to this collection of topics is established and a user profile for the user that has submitted the review is created by storing this pointer (or reference) together, of course, with information identifying the user that has submitted the acquired review.

In summary, following the submission of at least one review, a user profile for the user that has submitted the review is established.

Optionally, once said user profile has been created, i.e. once said review has been acquired and analyzed so has to determine a collection of topics associated with said user, the user profile is further filled with additional information, in particular explicitly or implicitly collected data.

Explicitly collected data is gathered by providing the user with questionnaires, surveys or polls that allow users to be directly asked about their personal needs and interests but also about more generic information such as the location, the gender, the marital status, etc. These explicitly collected data are then incorporated in step 104 into said user profile.

Implicitly collected data is gathered by deriving from the online browsing history, purchasing habits, social network public memberships, etc. These implicitly collected data are, if available, also incorporated in the user profile in step 105.

Preferably, the sequence of steps 101-105 is performed in a successive way as described above. However, alternatively, steps 101-105 can all be performed at the same time. It is furthermore also possible that steps 103 and 104 are performed periodically or continuously at different point in times that follow the submission of the review, thus totally independently from the execution of steps 101-102.

Hence, following the execution of the above described steps, a user profile, which comprises a reference to a collection of topics associated with the user, is created. This user profile, i.e. this collection of topics, is, on a first hand, thanks to the implementation of the concept which is to rely on a review submitted by the user himself in order to determine its needs and interests, de facto a reliable and pertinent manner of representing users personal needs and interests. On a second hand, the pertinence and reliability of the collection of topics created is even improved by the use of additional information, which include explicitly and implicitly collected data, during the process of generating the user profile.

Moreover, the method for generating a user profile in accordance with the present invention further comprises a step of dynamically updating said user profile. This step includes a step of periodically monitoring the availability of an additional review, or additional reviews, submitted by the user. An additional review can for example become available when the user purchases a new item and submits a new review. Additional reviews can also become available when online platforms merge together.

An additional review is treated the same way as a new review, i.e. it is analyzed exactly in the way described above. In particular, when an additional review becomes available, a step of performing an analysis of said additional review is performed. Such analysis allows an updated collection of topics to be generated.

Then, the updating step further includes a step of comparing a previously defined collection of topics with the updated collection of topics. A further step allows the collection of topics associated with the user to be adapted in accordance with the updated collection of topics.

The updating step can be performed independently from steps 101 and 102 or it can be performed in accordance with steps 101 and 102, a review being replaced in this case by an additional review.

Thus, the method for generating a user profile in accordance with the present invention is adaptive. It is indeed possible to follow the evolution of the user personal needs and interests over time and to adapt continuously the collection of topics associated with the user accordingly.

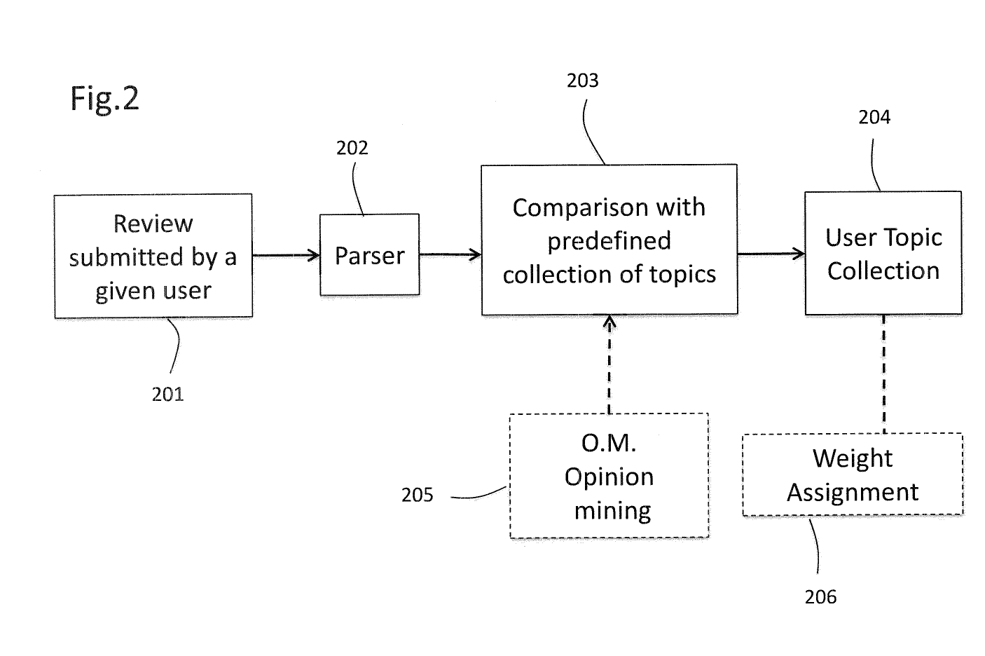

FIG. 2 shows further details on how the analysis step 102 is actually performed.

In step 201, which corresponds to step 101 of FIG. 1, a review submitted by a user is acquired. As it has been explained above, a review can be submitted as data in text format, multimedia format or both. A multimedia format is defined as including video formats (mpg, mov, etc.) and picture formats (jpg, bmp, gif, etc.).

In step 202, the review goes into a parsing step implemented by means of a parser which can perform several operations. A first possible operation realized by the parser concerns data which is submitted in text format. In this respect, the parser tokenizes the review first into words and then into sentences. For each sentence, a syntactic analysis is performed so as to determine, in those sentences, words or sets of words that are likely to provide useful information, i.e. information that in a way or another can be related in a meaningful way to a purchasable item. So-called “relevant sets of words” are then output for further analysis.

Another operation that can be performed by the parser during the parsing step 202 concerns reviews which do not contain only data in text format. In this case, the parser is able to transform a video, which by definition is not in text format, into a video-transcript in text format. The following operations described in the above paragraphs can then be performed directly on the video transcript. The same kind of procedure would apply to reviews which comprise pictures. In such a case, the parser is able to transform a picture into a picture description, i.e. a piece of data in text format, on which can be performed the above stated operations.

Alternatively, the parser can be substituted by image recognition means which makes it possible to derive directly from a video or a picture, the content which is addressed in it and, eventually, to transform such content into a piece of text, i.e. a set of words, on which the above stated operations can be performed.

The set of relevant words output by the parser are then compared in step 203 with a “predefined collection of topics”. A “predefined collection of topics” contains at least one topic that can be addressed in a review concerning a specific item. A predefined topic collection must thus be defined for each type of items, i.e. products or services, which can be purchased on the online platform. As it has been previously stated, a topic can be defined as one word, several words, several n-grams, etc. For example, when the considered item is related to hotel bookings, the predefined collection of topics could contain topics such as “cleanliness”, “proximity to center”, “noise”, “child friendly”, etc. When the considered item is a portable device, topics like “weight”, “quality of materials”, “battery life”, etc. could be included in the predefined collection of topics associated with the item “portable devices”.

The predefined collection of topics can be established by a set of human judges from their knowledge of topics that are important with respect to specific purchasable items. Those human judges will establish a list of topics, i.e. a predefined collection of topics, for each type of item that can be purchased on a platform.

Alternatively, the predefined collection of topics can be built by making use of artificial intelligence means. As it is well known to those skilled in the art, those means are first trained on a set of previously provided reviews in order to determine, from this content, a predefined collection of topics for each item that can be purchased on the online platform. Then, the artificial means can be continuously fed with new information so that they can further improve automatically their analyzing skills. Of course, the expression “artificial intelligence means” includes for example neuron networks, machine learning algorithms, support vector machines or any other type of artificial intelligence means well know to those skilled in the art.

The step 203, which consists in comparing the set of words output by the parsing module with a predefined collection of topics, makes it possible to determine if, amongst these set of words, they are expressions or words that can be found in the predefined collection of topics. Due to the performance of this analysis, the method for generating a user profile in accordance with the invention provides a way to identify in a review submitted by a user the information which is important and which must be reflected in the user profile.

The collection of topics associated with the user is thus generated at step 204 as output of the above described comparison.

Optionally, as shown in dotted lines on FIG. 2, the comparison of step 203 further includes a step 205 of making use of an opinion mining (O.M.) module which participate in the performance of the above described comparison step 203. The opinion mining module allows the review to be analyzed in a deeper manner so as to determine whether it contains sentiment-related information. The opinion mining module is thus able to determine in a better way if some information is really useful or not.

For example, from the review “I walked into the room”, the opinion mining module would determine that, even if the word “room” appears, the review must not be taken into account since it is not linked in any manner to any sentiment-related information. In contrast, the review “the room was clean” would be treated differently. The opinion mining module would be able to determine that the word “room” is related to another word, namely “clean”, which provides information about a sentiment, in particular about the sentiment of the user with respect to the cleanliness of the room.

Of course, always bearing in mind that a review can contain data which is not in text format, in particular when a review contains data which is in multimedia format, the O.M. module could be enhanced with further means that allow sentiment-related information to be determined from reviews which are submitted as videos or pictures.

For example, the O.M. module would, in this respect, be able to determine, from the face of a user shown on a picture or video, whether the sentiment at a certain point in time of the video differs from a sentiment at another point in time. To reach this goal, the O.M. module would be provided with facial recognition means and with other artificial intelligence means well known to those skilled in the art that would allow sentiment-related information to be determined from a video or a picture.

By following the steps as described above, the method for generating a user profile in accordance with the present invention thus makes it possible to derive, from a single review a reliable, pertinent and complete collection of topics for a user.

The method further makes it possible, as an alternative, to assign equal or different weights to the topics contained in the user collection of topics. Indeed, the method can further comprise a step 206 which consists in assigning the same or different weights to the topics contained in the generated collection of topics. The method described above thus allows the same or a different importance to be given to different topics. Assigning none or the same weight to all topics, for example defined by an integer value, would be equivalent to establish that all the topics have the same importance. In contrast, assigning different weights, i.e. different integer values for example, to different topics would establish that some topics are more or less important than others.

Of course, this weight assignment step 206 can be performed at the same time as the review is analyzed. Alternatively, it can be performed totally independently form this analysis. The weights can also be assigned to the topics when the user collection of topics has already been generated. In any case, the weight assignment step 206 outputs a weighted collection of topics.

The choice of specific weights corresponding to specific topics can for example depend from the number of occurrences of a word in review, the position of words in a review, the importance of a topic defined in the predefined collection of topics, etc.

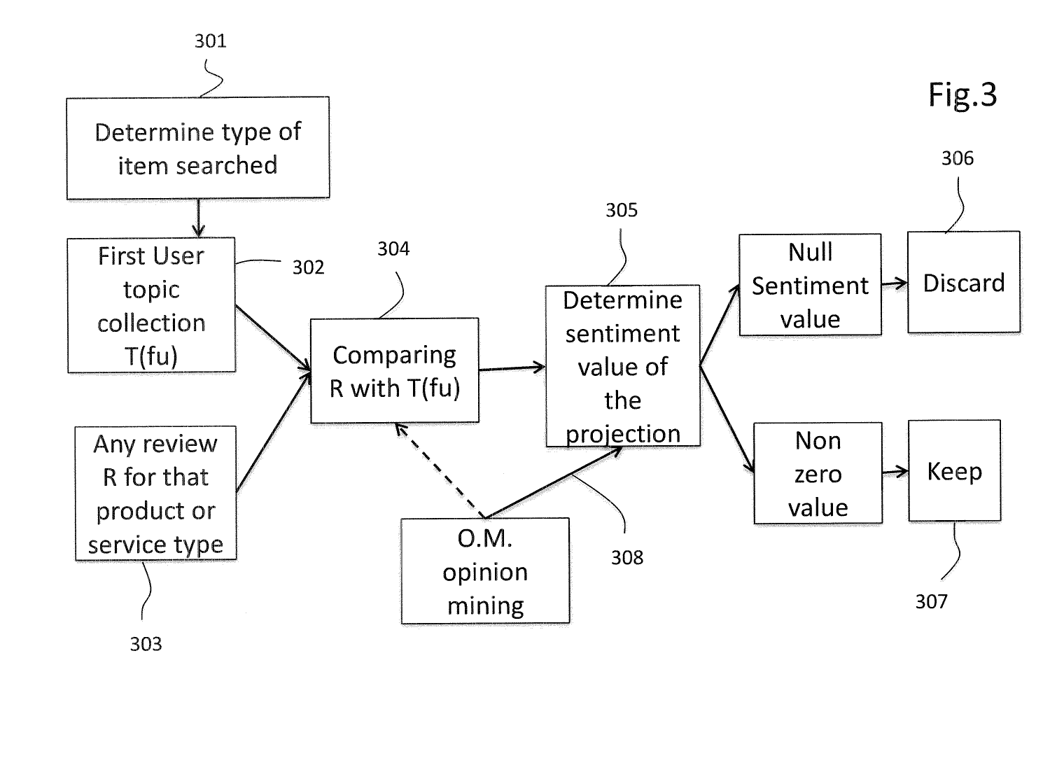

A second aspect of the present invention will now be explained in reference to FIGS. 3-5.

The second aspect relates to a computer-implemented method for providing a first user with targeted information when said first user enters into a process of looking for an item purchasable on an online platform. The method which is described below is preferably implemented as soon as a user of an online platform enters into a process of looking for an item purchasable on an online platform. As it is well known to those skilled in the art, an e-commerce online platform is usually provided with searching means, i.e. means that can be used by a user to specify search-related parameters describing in a generic way a type of item that said user is looking for. As it is well known, online e-commerce platforms are usually provided with a search bar, similar to a search bar that can be found on any sear engine (google, bing, etc.) or on any e-commerce website (amazon, itunes, etc.). The user makes use of this searching means for specifying the type of item that he is looking for. Search-related parameters are for example “hotel las vegas”, “laptop computer”, “digital camera less expensive than 600$”, etc. Within the spirit of the present invention, a user enters into a process of looking for an item as soon as he submits a query to an online platform, either in text or multimedia format.

FIG. 3 illustrates a first embodiment of the method for providing a first user with targeted information in accordance with the present invention. In this embodiment, the method comprises a step 301 of determining the type of item that the user is looking for. For example, from a query “hotel las vegas” submitted it can be assumed that the user is looking for a hotel in Las Vegas. The type of item in this case is thus defined to be “hotels in Las Vegas”. The type of item is later on used, as will be described below, to retrieve information from the online platform, in particular reviews previously submitted by other users, which concerns this type of items. In the present case, it is reviews related to hotels in Las Vegas that are likely to provide useful information and that will thus be retrieved.

In step 302, the user profile associated with the first user is retrieved from the online platform. It further allows the collection of topics which is associated with the first user to be retrieved. It is important to notice here that the user profile, i.e. the collection of topics, associated with the first user may have been generated in accordance with the method for generating a user profile of a user of an online platform described above. It is however possible to apply the method for providing a first user with targeted information in accordance with the second aspect of the present invention even if the user profiles have not been generated in accordance with the method for generating a user profile in accordance with the present invention, this being the case as long as the user profiles associate a user with a collection of topics comprising at least one topic.

In step 303, all the reviews which have been submitted by other users, i.e. distinct from the first user, and which concern items of the type searched by the first user are retrieved from the online platform. An initial filtering of the found reviews may be performed, so as to discard all reviews whose submission date is older than a predefined threshold. As a result of step 302, at least one review which concerns an item of the type searched by the first user is thus retrieved.

The retrieved reviews, if more than one review is retrieved, are then compared, in step 304, with the collection of topics associated with the first user. In this way, the method determines, for each review retrieved, if it contains information that addresses, in one way or another, the topics contained in the collection of topics associated with the first user. Step 304 establishes, for each retrieved review, whether it provides information which is related, i.e. pertinent, with the first user's personal needs and interests as defined in the first user's collection of topics.

In a following step 305, it is determined for each retrieved review, whether it provides sentiment related information. This step further improves the analysis of the retrieved reviews by taking into account only the reviews that contain sentiment-related information. A review such as “the room was clean” provides for example sentiment-related information with respect to the topics “cleanliness of the room” whereas the review “I walked into the room” does not provide sentiment-related information with respect to such topic. Therefore, even if the word “room” appears in both reviews, i.e. the topic “cleanliness of the room” seems a priori to be addressed in both of the above described reviews, it is obvious that only one of these reviews, the second one, really provides useful information, i.e. information which is pertinent to the first user's personal needs and interests. The method in accordance with the present invention reacts to such difference by assigning in step 305 a specific value, a so-called “sentiment value”, to each one of the retrieved review. Coming back to the reviews mentioned above, a value of “0” could for example be assigned to the first review whereas a value of “1”, or any other integer”, could be assigned to the second one.

Preferably, reviews that are in step 305 assigned the value of “0” are discarded in step 306 from further processing whereas reviews that have been assigned a sentiment value different form 0 are kept in step 307 for further processing.

Similarly to what has been disclosed in reference to FIG. 2, the implementation of step 305 of FIG. 3 preferably includes a step 308 of making use of an opinion mining module O.M. which automatically retrieves sentiment-related information.

Optionally, the O.M. module can also be used when step 304 is performed, i.e. when a retrieved review is compared to the topic collection associated with the first user. This optional step, indicated in doted lines on FIG. 3, makes possible to determine at an early stage already whether an analyzed review contains sentiment-related information. The implementation of this optional step can further decrease the time necessary for analyzing the retrieved reviews.

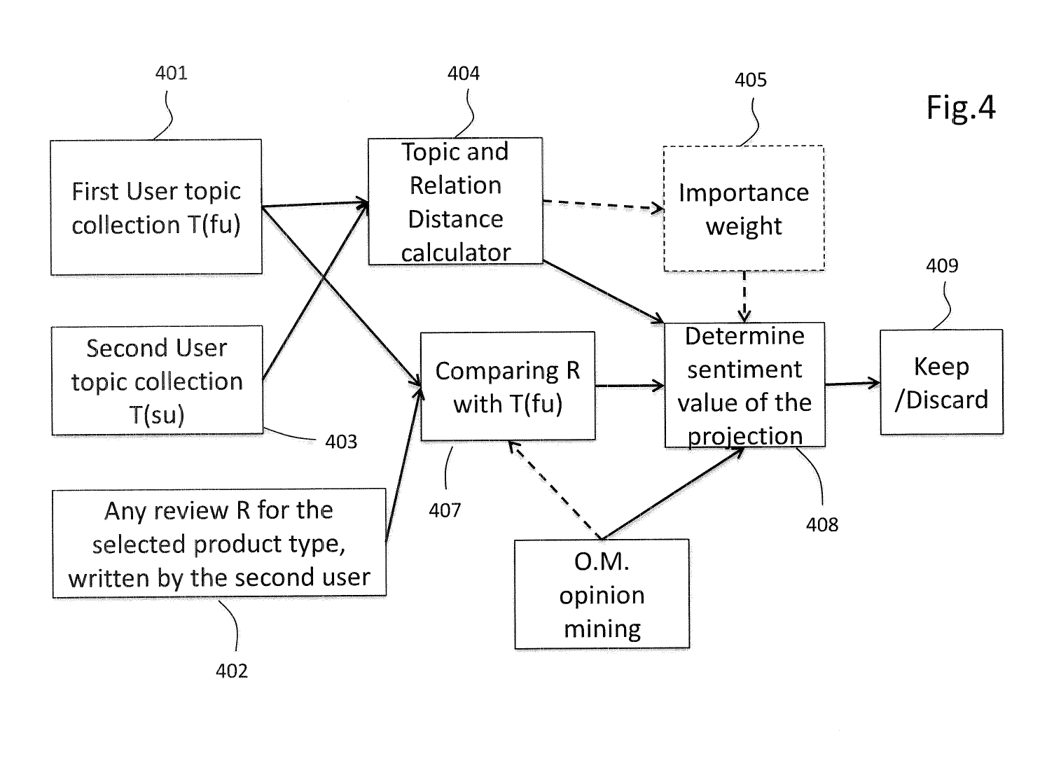

FIG. 4 illustrates a second embodiment of the method for providing a first user with targeted information in accordance with the present invention. The second embodiment makes use of additional steps that further improve the pertinence of the information which is at the end provided to the first user.

The first step 401 of the method in accordance with the second embodiment includes steps 301 and 302 of the method described with respect to the first embodiment. As such, the performance of step 401 allows, on one hand, the item type to be determined and, on the other hand, the user collection associated with the first user to be retrieved.

In step 402, which corresponds to step 303, are retrieved reviews which somehow address the type of item that the first user is looking for and meet any imposed constraints on their submission date.

In an additional step 403, it is determined, for each review retrieved, the identity of a second user which is associated with the review. This step allows the user profile associated with the second review either to be retrieved from the online platform or to be built on the fly, if it has not been generated previously, from information contained in the review. The step 403 allows in summary a second collection of topics to be derived or determined.

Following the determination of a second collection of topics, i.e. the collection of topics that is associated with the second user to which an analyzed review is associated, a distance factor characterizing the proximity between the first collection of topics, i.e. the collection of topics associated with the first user, and the second collection of topics, i.e. the collection of topics associated with the second user associated with the analyzed review, is determined in step 404. The distance factor thus somehow characterizes the existence of a possible compatibility between the first user personal needs and interests with respect to those of the second user. This step of the method in accordance with the second embodiment thus further increases the analysis of the retrieved reviews by further determining whether people that have submitted reviews are likely to share personal interests and needs with the first user, i.e. to provide information that might be useful for the first user.

Optionally, step 404 further includes a step of determining a relation factor for the second user. A relation factor, which can, for example, be established by analyzing implicitly collected data in the user profiles, is at least dependent form the existence of a relationship between the first user and the second user. The existence of a friendship link in social networks can for example be used to determine the relation factor. Explicitly collected data can also be used to determine the relation factor, for example if a user has filled a questionnaire in which he has submitted that he has a particular relationship with other users.

The determination of a relation factor further improves also the analysis of a review with respect to a user by taking into account proximity of interests and relationship dependence. For example, it is thus possible to take into account that the reviews submitted by people who are somehow related to the first user are more likely to provide useful information to the first user than those submitted by others.

In a further optional step 405, a weight can be assigned to a second user in accordance with the relation and distance factors.

In parallel to the performance of steps 404, and optionally 405, each retrieved review, i.e. reviews that address the type of item that the first user is looking for, are compared in step 407 with the collection of topics associated with the first user. Similarly to what has been described in reference to FIG. 3, step 407 can further include a step of making use of an O.M. module for determining, at an early stage already, whether an analyzed review contains sentiment-related information.

In step 408, a sentiment value is determined for each review analyzed. In a similar way to what has been described with respect to step 305 of FIG. 3, a so-called sentiment value is determined for each analyzed review. Similarly also, the use of the O.M. module allows an automatic determination of the sentiment-related content provided in each analyzed review.

As shown by doted lines, the weights that have been allocated to the users in accordance with the relation and distance factors can, if desired, be taken into account for the computation of the sentiment value in step 408.

The second embodiment of the method in accordance with the present invention thus provides means for increasing the pertinence of the information in accordance with the first user personal needs and interests. Only information that is highly likely to provide the first user with useful information is selected.

Finally, it is determined in step 409, for each review retrieved, whether it should be taken into account or not. Reviews that are likely to provide useful information, as determined by the performance of the previous steps, are kept whereas, in contrast, reviews that are not likely to provide useful information are discarded from further processing.

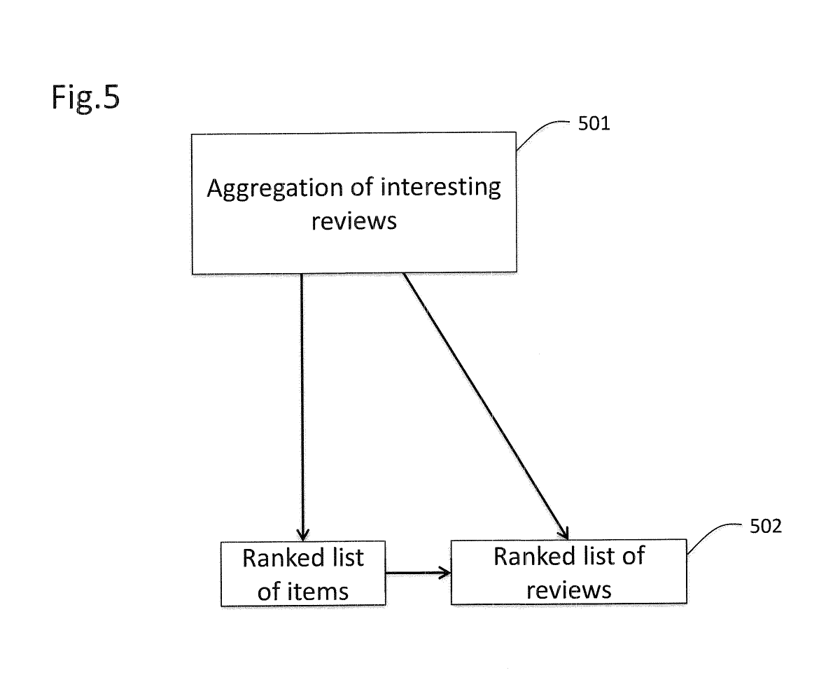

FIG. 5 illustrates the last steps performed in both embodiments of the method for providing a first user with targeted information described above. It has indeed been established how it is possible to differentiate, from a set of reviews that all address the same type of item, those reviews that have to be kept and those that have to be discarded.

In a step 501, the method in accordance with the present invention aggregates all the kept reviews. The kept reviews are those which have been kept following performance of the steps as disclosed with respect to the first and second embodiment of the method for providing a first user with targeted information.

The last step 502 of the method in accordance with the present invention can then consist in a step of presenting the first user with a ranked list of reviews that, following the performance of the steps as disclosed above, have been determined as likely to provide useful information. The reviews are ranked in accordance with the sentiment values that have been previously determined. The reviews that have the highest sentiment value are those that have a higher chance to provide useful information to the first user. Consequently, a higher rank is thus assigned to these reviews.

Alternatively, instead of providing the first user with a ranked list of reviews, i.e. providing the user with recommendations of reviews to be read, it is possible to output a ranked list of purchasable items. From the kept reviews, it is indeed possible to retrieve not only the type of item to which they relate but also specific items for which such reviews have been submitted. It is thus possible to establish, from the analysis of the reviews only, a ranked list of items that are highly likely to correspond to the needs and interests of the first user.

Alternatively, step 502 can thus consist in outputting a ranked list of purchasable items.

Of course, a ranked list of reviews and a ranked list of purchasable items can be output together. Moreover, the ranked list of items may comprise only the items with the highest ranks. Similarly, the ranked list of reviews may comprise only the reviews with the highest ranks.

A third aspect of the present invention concerns a computer-implemented method for providing a user of an online platform with targeted advertisements.

A first step of this method consists in retrieving from an online platform a user profile associated with a user. Preferably, the user profile has been previously generated in accordance with the method for generating a user profile in accordance with the present invention described above. In this case, the user profile contains a reference, i.e. a pointer, to a collection of topics associated with the user. It is nevertheless possible to apply the method for providing a user of an online platform with targeted advertisements even if the user profile has not be generated in that way, as long as the user profile comprises a pointer, a reference or a link, to a collection of topics associated with the user.

The second step of the method makes use of a collection of advertisements that contains at least one advertisement. For each advertisement are defined advertising parameters. Advertising parameters can for example define marketing targets, i.e. targeted audience.

The second step of the method for providing a user with targeted advertisements in accordance with the present invention consists in comparing, for each advertisement contained in the collection of advertisements, the collection of topics associated with a user with the advertising parameters. A pertinence factor is determined for each advertisement with respect to the collection of topics associated with the user. The pertinence factor characterizes the pertinence of an advertisement with respect to a user personal needs and interests, as defined in the collection of topics associated with the user via the user profile. A high pertinence factor thus characterizes that such advertisement is likely to be in line with a user personal needs and interests whereas a low pertinence factor characterizes that such advertisement is not likely to be pertinent for the user.

The last step of the method for providing a user with targeted advertising consist in presenting an advertisement to a user in accordance with the pertinence factor. Of course, if the advertising space in which advertisements can be presented to a user is limited, advertisements which have a higher pertinence factor will be presented first to the user.

The above described methods are implemented by making use of hardware and software means. An installation or a system comprising hardware and software means implementing an online platform and the above described method is also part of the present invention. These hardware and software means comprise at least one processor that executes computer-executable code stored in memory to effect the steps as defined with respect to the methods described above, namely the method for generating a user profile of a user of an online platform, the method for providing a first user with targeted information and the method for providing a user of an online platform with targeted advertisements. The hardware and software means employ at least one processor executing computer-executable instructions stored on a computer-readable storage medium to implement the methods.

What is claimed is:

1. A computer-implemented method for generating a user profile of a user of an online platform, said method comprising the steps of:
acquiring a review submitted by said user, wherein said review concerns an item purchasable on said online platform and contains data in formats selected from a group consisting of text format, multimedia format and combinations thereof;
performing an analysis of said review so as to generate a collection of topics associated with said user, wherein said collection of topics contains at least one topic; and
creating said user profile by storing a reference to said collection of topics in relation with information identifying said user.

2. The method of claim 1, further comprising the step of incorporating explicitly collected data in said user profile.

3. The method of claim 1, further comprising the step of incorporating implicitly collected data in said user profile.

4. The method of claim 1, wherein said step of performing an analysis of said review includes a step of deriving, from said review, at least one data part in text format and a step of parsing said data part so as to retrieve from said data part at least one relevant set of words, wherein said set of words comprises at least one word.

5. The method of claim 4, wherein said step of performing an analysis of said review includes a step of comparing said set of words with a predefined collection of topics.

6. The method of claim 5, wherein said predefined collection of topics is established by a set of human judges.

7. The method of claim 5, wherein said predefined collection of topics is built by making use of artificial intelligence means.

8. The method of claim 4, wherein said step of performing an analysis of said review includes a step of determining sentiment-related information contained in said review.

9. The method of claim 8, wherein said step of determining sentiment-related information includes a step of making use of an automated sentiment determination module so as to determine if at least one word contained in said at least one data part provides sentiment-related information.

10. The method of claim 1, wherein said step of performing an analysis of said review includes a step of determining sentiment-related information contained in said review and said step of determining sentiment-related information includes a step of making use of an automated sentiment determination module which automatically determines at least one part of said review which provides sentiment-related information.

11. The method of claim 1, wherein said step of creating a user profile for said user includes a step of assigning a weight to each topic contained in said collection of topics.

12. The method of claim 1, further comprising a step of dynamically updating said user profile, wherein said step of dynamically updating said user profile comprises a step of periodically monitoring the availability of an additional review submitted by said user, a step of performing an analysis of said additional review so as to generate an updated collection of topics and a step of comparing said collection of topics with said updated collection of topics so as to adapt said collection of topics in accordance with said updated collection of topics.

13. A computer-implemented method for providing a first user with targeted information when said first user enters a process of looking for an item purchasable on an online platform by providing, by means of dedicated searching means provided on said online platform, at least one search-related parameter, said method comprising the steps of:
determining, by making use of said at least one search-related parameter provided by said first user, a type of item said first user is looking for;
retrieving, from said online platform, a first user profile associated with said first user, wherein said first user profile is linked to a first collection of topics comprising at least one topic;
retrieving, from said online platform, at least one review which concerns an item of said type and which has not been submitted by said first user;
comparing said review with said first collection of topics so as to determine whether said review includes content that relates to at least one topic contained in said first collection of topics; and
assigning a sentiment value to said review.

14. The method of claim 13, wherein said step of retrieving said reviews which concern an item of said type and which have not been submitted by said first user includes a step of discarding those reviews for which the time elapsed between the moment of their submission and the present exceeds a predefined threshold.

15. The method of claim 13, wherein said step of comparing said review with said first collection of topics includes a step of determining whether said content provides sentiment-related information.

16. The method of claim 13, further comprising the steps of:
determining, from said online platform, which second user submitted said review so as to derive a second collection of topics associated with said second user; and
comparing said first collection of topics with said second collection of topics so as to determine a distance factor for said second user, wherein said distance factor is dependent from the pertinence of said second collection of topics with respect to said first collection of topics.

17. The method of claim 16, further comprising a step of determining a relation factor for said second user, wherein said relation factor is dependent from the existence of at least one relationship between said first user and said second user.

18. The method of claim 13, further comprising a step of providing said first user with a ranked list of purchasable items of said type.

19. The method of claim 13, further comprising a step of providing said first user with a ranked list of reviews that concern items of said type.

20. The method of claim 15, wherein said step of determining whether said content provides sentiment-related information includes a step of making use of an automated sentiment determination module which automatically determines at least one part of said review which provides sentiment-related information.

21. A computer-implemented method for providing a user of an online platform with targeted advertisements, said method comprising the steps of:
retrieving, from said online platform, a user profile associated with said user, wherein said user profile is linked to a collection of topics comprising at least one topic;
comparing said collection of topics with advertising parameters associated with an advertisement contained in a collection of advertisements so as to determine a pertinence factor of said advertisement with respect to said user; and
presenting said advertisement to said user in accordance with said pertinence factor.
